(19) United States
(12) Patent Application Publication
(10) Pub. No.: US 2004/0204070 A1
(43) Pub. Date: Oct. 14, 2004

(54) Wireless service provider functionality to transfer designated configuration information

(76) Inventors: Katherine G. August, Matawan, NJ (US); Joseph M. Cannon, Harleysville, PA (US)

Correspondence Address: MANELLI DENISON & SELTER PLLC, 7th Floor, 2000 M Street, N.W., Washington, DC, 20036-3307, US

(21) Appl. No.: 10/125,443

(22) Filed: Apr. 19, 2002

(51) Int. Cl. H04B 1/38

(52) U.S. Cl. 455/557; 455/426.1; 455/552.1

(57) ABSTRACT

A system and method for remotely accessing configuration information is disclosed. A remote computer sends a request for configuration information from a cellular phone. The cellular phone responds to the request for configuration information by forming a data packet containing the configuration information. The data packet is sent to the remote computer where it is stored on permanent storage for later retrieval.

### BACKGROUND OF THE INVENTION

1. Field of the Invention

This invention relates generally to providing a method and apparatus for transferring data from a mobile phone. More particularly, it relates to a system and method of transferring configuration data from a mobile phone.

2. Background of Related Art

Mobile phones, Personal Data Assistants (PDA), and other mobile wireless devices are small, portable, and easily stolen. If a mobile phone or other hardware is stolen or misplaced, there is a possibility that the owner of the mobile phone or other mobile device will lose important configuration information stored therein.

Configuration information is information that is programmably stored into the phone during ownership. Configuration information includes, e.g., call logs (phone numbers received, phone numbers called, timestamps of phone calls, long distance calls made, local calls made, costs of calls), voice message logs, text message logs, missed call logs, remaining free minutes, address book information (names, phone numbers, addresses, e-mail addresses, personal information, birthdays), personal tones stored, digital images, schedules, appointments, Personal Identification Number (PIN) numbers, mail box messages, internet bookmarks, volume preferences, display preferences, etc.

One conventional way to protect information within a portable device, such as a personal data assistant (PDA), is to use a docking station. Using such a system, the PDA's information is stored in an external device such as a personal computer for archival purposes.

FIG. 6 illustrates a conventional system for connecting a PDA to a personal computer comprising a PDA 510, a docking station 520, a communication wire 530, a personal computer 540, a communication port 550, a synchronization button 560, and permanent storage 570 within the personal computer 540.

In particular, as shown in FIG. 6, the conventional PDA 510 is placed in a docking station 520. The coupling of the PDA 510 with the docking station 520 allows the transfer of information between the PDA 510 and the personal computer 540. A synchronization button 560 on the front panel of the docking station 520 is depressed by a user to initiate a transfer of data between the PDA X10 and the personal computer 540. Data from the PDA 510 passes through the docking station 520, over the communication wire 530, through the communication port 550 on the personal computer 540, and stored in permanent storage 570 with the personal computer 540.

The permanent storage 570 can include, e.g., a hard disk, optical storage, tape storage, a Zip disk, etc. Any permanent storage is suitable that allows for future retrieval of the data in the event the personal data assistant looses its data.

Cellular services such as those offered by Global Systems for Mobile Communications (GSM), General Packet Radio Service (GPRS), Enhanced Data for GSM Evolution (EDGE), Code Division Multiple Access (CDMA), Personal Communication Services (PCS) and others have recently allowed for data transmissions of substantial size to become a reality.

FIG. 7 illustrates a conventional system for transferring data from an external data source, such as the internet, to a cellular phone comprising a cellular phone 610, a cellular phone's keypad 615, a cellular phone display 617, a cellular network 620, a data router 630, a high speed internet connection 640, and a remote server 650.

In particular, the cellular phone 610 initiates a request for data from the internet by a user pushing a key sequence on the cellular phone's keypad 615. The request from the cellular phone 610 for data passes over the cellular network 620, through the data router 630, to the high speed internet connection 640. Cell network 620 typically comprises mobile switching center (MSC), home location register (HLR), base station controller, etc., and usually MSC provides an interface to the Internet. The request for data from the internet then is obtained from a remote server 650, as is well known within the art to service a request for data over the internet.

The remote data server 650 sends the requested data over the same path as described above for sending the request, simply in the reverse order. The cellular phone 610 receives the requested data from the internet. The data is formatted for easy viewing on the cellular phone's display 617 by the cellular phone 610.

A cellular phone with internet capability can be programmed to automatically retrieve information such as sports scores, stock quotes, e-mail, etc.

The system as described with relation to FIG. 7 is also used to transfer data to and from other mobile wireless devices, such as PDAs. PDAs, such as the popular PALM PILOT™, are now being sold with the option of a cellular transceiver that allows a user to connect to the internet. Transceivers allow both the transmission and reception of information.

Using a hardwired backup procedure or wirelessly connecting to the internet allows a user using existing devices to initiate a transfer of data to and from mobile devices, but does not assist a user in retrieving configuration information from a mobile device if the device is lost or stolen.

There exists a need for an apparatus and method that allows a user to remotely retrieve configuration data from a lost or stolen mobile device for transfer to a replacement mobile device.

### SUMMARY OF THE INVENTION

In accordance with the principles of the present invention, a system for remotely accessing configuration information comprises a portable wireless device having a radio transceiver. A remote computer accesses the portable wireless device to obtain the portable wireless device's configuration information.

In accordance with the principles of another aspect of the present invention, a method of remotely accessing configuration information associated with a particular wireless device comprises transceiving a data signal from a remote computer, and accessing the portable wireless device from the remote computer to obtain the configuration information belonging to the portable wireless device.

In accordance with the principles of another aspect of the present invention, a method of providing configuration information to a remote computer comprising receiving a configuration information request signal from the remote computer, formatting the configuration information, and sending the configuration information to the remote computer.

In accordance with the principles of another aspect of the present invention, a method of remotely accessing configuration information comprising transceiving a data signal from a remote computer, monitoring for a return of the configuration information from a portable wireless device, and when the step of monitoring for a return of the configuration information returns the configuration information, storing the configuration information on a permanent storage device.

### BRIEF DESCRIPTION OF THE DRAWINGS

Features and advantages of the present invention will become apparent to those skilled in the art from the following description with reference to the drawings, in which:

FIG. 1 shows a cellular phone connected to a remote personal computer over the internet for backing up configuration information in accordance with the principles of the present invention.

FIG. 2 shows a cellular phone remotely connected to a personal computer over a PSTN for backing up configuration information in accordance with the principles of the present invention.

FIG. 3 shows a flowchart of a cellular phone responding to a backup request from a remote location, in accordance with the principles of the present invention.

FIG. 4 shows a flowchart of a remote personal computer initiating a configuration information request to a cellular phone, in accordance with the principles of the present invention.

FIG. 5 shows a flowchart of a remote personal computer initiating a request to transfer configuration information backup data to a cellular phone, in accordance with the principles of the present invention.

FIG. 6 shows a conventional system for backing up data stored on a PDA.

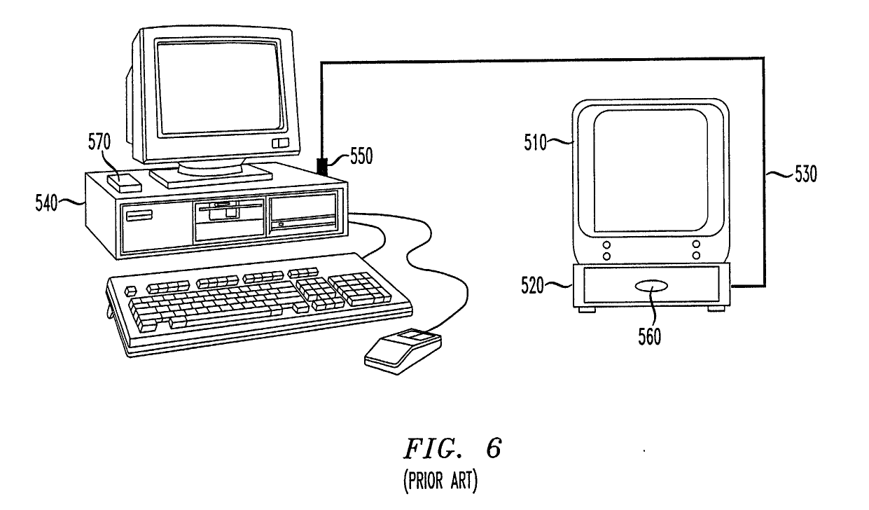

FIG. 7 shows a conventional cellular telephone having internet capability.

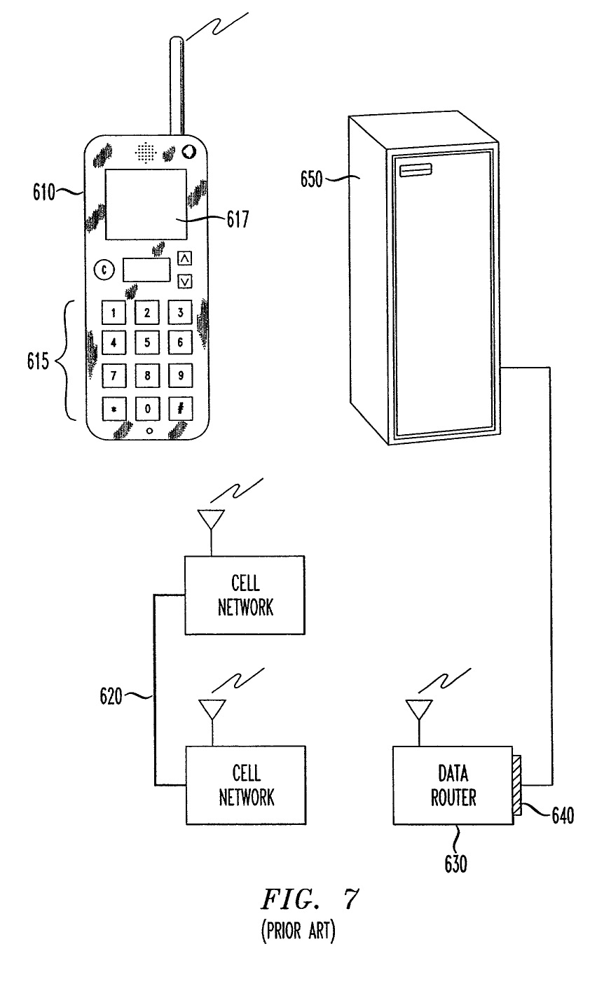

### DETAILED DESCRIPTION OF ILLUSTRATIVE EMBODIMENTS

The present invention provides a method and apparatus for wirelessly backing up configuration information stored on a cellular phone to a remote personal computer.

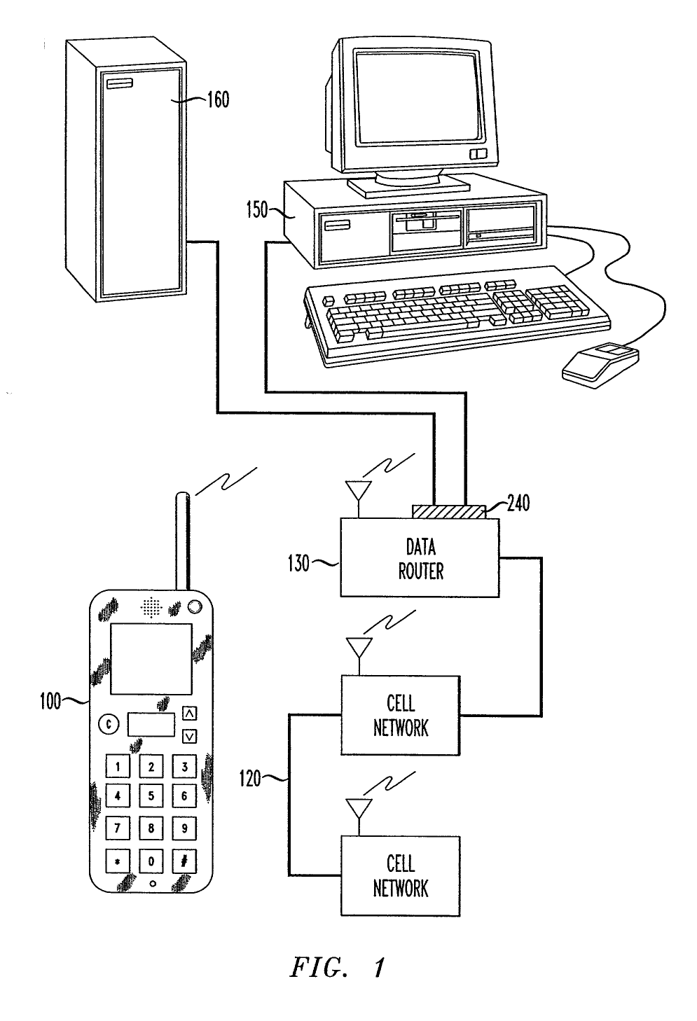

FIG. 1 shows a cellular phone connected to a remote personal computer over the internet for backing up configuration information in accordance with the principles of the present invention.

In particular, FIG. 1 illustrates a system for transferring configuration data from a cellular phone to a remote personal computer over the internet comprising a cellular phone 100, a cellular network 120, a data router 130, a high speed internet connection 140, a remote personal computer 150, and a cellular phone company internet server 160.

The remote personal computer 150 connects to an internet page hosted by a cellular phone company's internet server 160 through a transceiver, which is able to transmit or receiver information. The user having the desire to obtain configuration information from a cellular phone 100 enters pre-established account information in a web page for generating a configuration information request from the cellular phone 100. The cellular phone company's internet server 160 then sends a request for the data to be transferred to the remote personal computer 150.

A request for data from a remote personal computer 150 is routed over a high speed internet connection to a data router 130. The data router 130 sends the request for data over the cellular network 120 to the cellular phone 100. The cellular phone 100 responds to the request for data from the remote personal computer 150 by forming its configuration data into a data packet and sends the data in the reverse path as the request was sent, as described above. The configuration data packet is routed to the remote personal computer 150, where the information is stored on some form of permanent storage that allows future retrieval, e.g., a hard disk, optical storage, tape storage, a Zip disk, etc. Any permanent storage is suitable that allows for future retrieval of the data in the event the personal data assistant looses its data.

In the event that the cellular phone 100 is non-operational when the initial request for its configuration data is made, the internet server 160 stores the request and monitors whether the request was serviced by the cellular phone 100. If the request was not serviced, the internet server 160 maintains communication with cellular network 120. Cellular network 120 determines when cellular phones become active on the cellular network 120 at any given time. Activating a cellular phone gives notice to the internet server 160 that the phone is available for access. Internet server then re-attempts a configuration data request from the cellular phone 100.

In the event the remote personal computer 150 is unavailable to receive the cell phone configuration data obtained during a re-attempt, the cell phone configuration data is stored on the internet server 160. The next time a user connects to the internet server 160, notice is given to the user desiring access to the cell phone configuration data that the data is now available for download. The user then transfers the configuration data by initiating a transfer request from the remote personal computer 150 to the internet server 160. The request for data is responded to by the internet server 160 by a transfer of the configuration data from the internet server 160 to the remote personal computer 150.

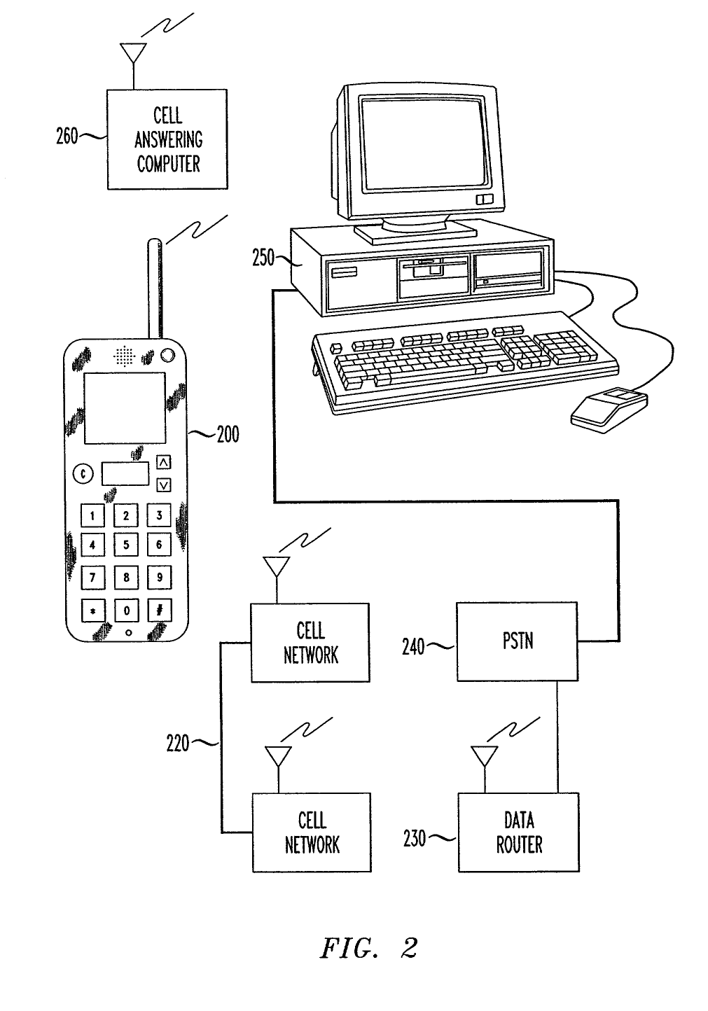

FIG. 2 shows a cellular phone remotely connected to a personal computer over a Public Switched Telephone Network (PSTN) for backing up configuration information in accordance with the principles of the present invention.

In particular, FIG. 2 illustrates a system for transferring configuration data from a cellular phone to a remote personal computer over a PSTN comprising a cellular phone 200, a cellular network 220, a data router 230, a PSTN 240, a remote personal computer 250, and a cellular phone answering computer 260.

The remote personal computer 250 makes a request for the configuration data stored on the cellular phone 200. A modem within the remote personal computer 250 translates the request for transmission over a PSTN 240.

The configuration information request is routed from the PSTN 240 through a data router 230. The data router directs the signal to be placed on the cellular network 220. The cellular network 220 routes the configuration information request to the cellular phone 200.

The cellular phone 200 responds to the configuration information request by forming its configuration data into a data packet. The data packet is sent in the reverse path as the configuration information request was sent, as described above. The configuration information data packet is routed to the remote personal computer 250, where the information is stored on some form of permanent storage that allows future retrieval.

In the event that the cellular phone 200 is non-operational when the initial request for its configuration data is made, the configuration request can be routed and stored in a cellular phone answering computer 260, normally used to respond to a call when the cellular phone is unavailable for answer.

The cellular phone answering computer 260 answers for the cellular phone 200 when the cellular phone is unavailable for answer. With normal voice communication, a conventional voice recording allows a caller to leave a message for a cellular phone's user. With a configuration information request, the cellular phone answering computer 260 distinguishes a configuration request form a voice message and stores the configuration information request. The next time the cellular phone 200 connects to the cellular network 220, the cellular phone answering computer 260 initiates the configuration information request to the cellular phone 200.

The configuration information request is responded to by the cellular phone 200 as described above. The configuration information data is stored on the cellular phone answering computer 260. Thereafter, when a request for configuration information is unobtainable from the cellular phone 200, a subsequent transfer to the cellular phone answering computer 260 will allow the remote personal computer to access the desired configuration information available the previous time the cellular phone 200 was connected to the cellular network 220.

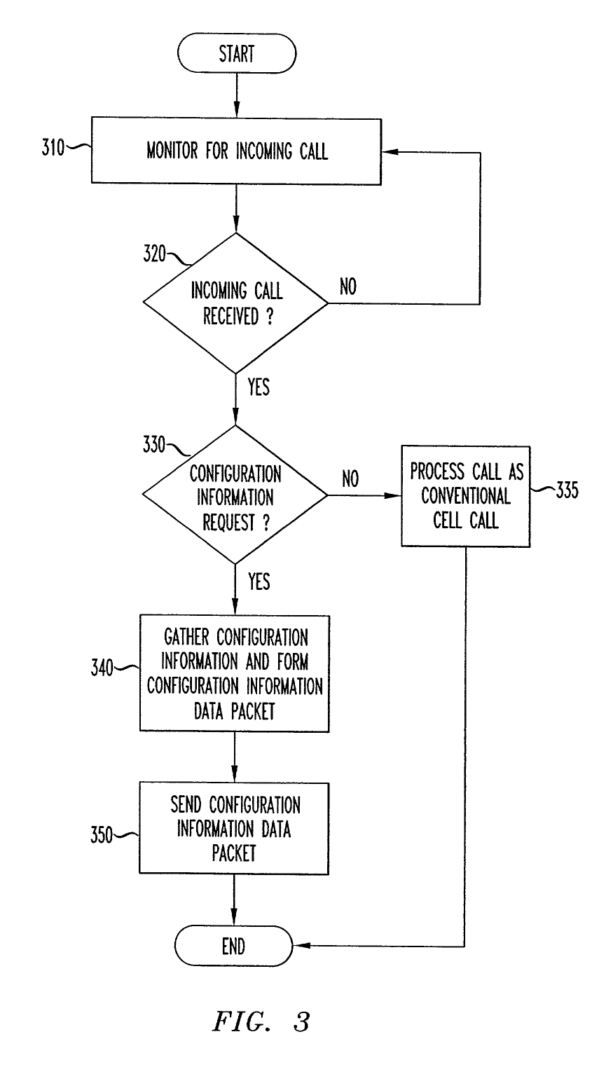

FIG. 3 shows a flowchart of a cellular phone responding to a backup request from a remote location, in accordance with the principles of the present invention.

In step 310, a software routine within the cellular phone monitors for an incoming call.

In step 320, a decision is made if an incoming call has been received by the mobile phone.

If no incoming call has been received, the program loops back to step 310 to continuously monitor for an incoming call.

In step 330, if an incoming call is available, the program determines if the incoming call contains a configuration information request.

If no configuration information request is attached to the call, the program branches to step 335, where the cellular call is handled as a conventional call to a cellular phone.

If the incoming call does contain a configuration information request, step 340 gathers the configuration information and formats a data packet containing the configuration information.

In step 350, the data packet containing the configuration information is sent over the cellular network for transfer to a remote personal computer, as shown in FIGS. 1 and 2, items 150 and 250 respectively.

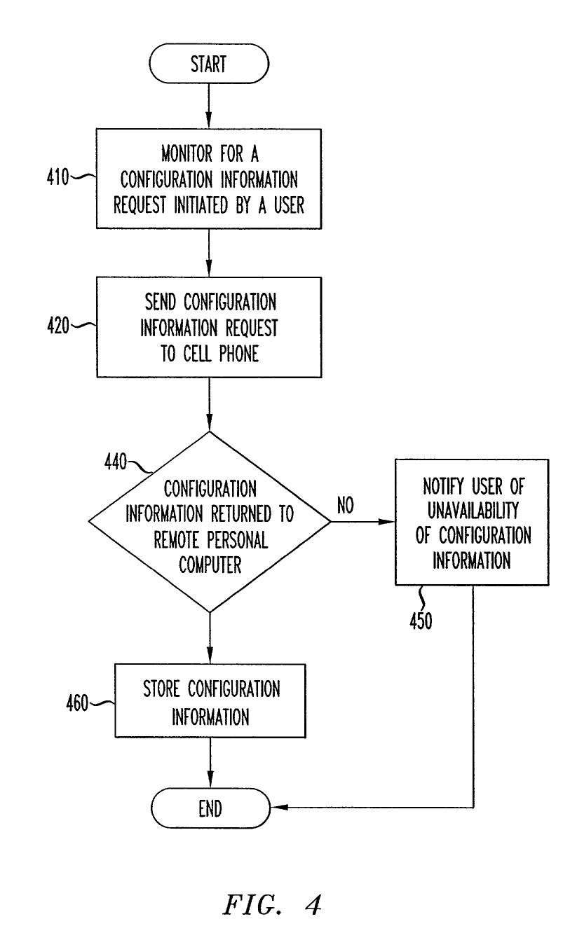

FIG. 4 shows a flowchart of a remote personal computer initiating a configuration information request to a cellular phone, in accordance with the principles of the present invention.

In step 410, a remote personal computer monitors for a configuration information request initiated by a user of the remote personal computer.

In step 420, the configuration information request is sent to the cellular phone, either by making a connection through the internet, calling the cellular phone, or any other available method of obtaining a remote connection to the cellular phone.

In step 440, a decision is made If configuration information is returned to the remote personal computer. If no configuration information is returned by the cellular phone, step 440 branches to step 450.

In step 450, notification is given to the user of the remote personal computer that the configuration information of the cellular phone is not currently available, and the user should retry gaining access to the cellular phone at a later time.

If the configuration information is returned by the cellular phone, step 460 stores the configuration information on a permanent storage device for later retrieval.

Transfer of information from a remote personal computer to a replacement cellular phone is conducted over the same hardware that is described above for backup of the configuration information associated with the cellular phone.

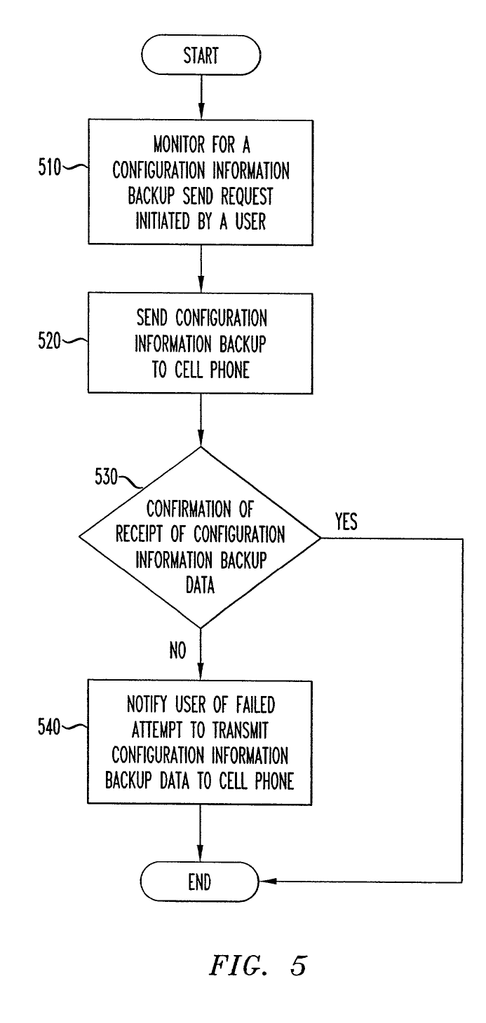

FIG. 5 shows a flowchart of a cellular phone responding to a request to transfer backup configuration information from a remote personal computer to a cellular phone.

In step 510, a user at a remote personal computer initiates a request to send configuration information backup data to a cellular phone.

In step 520, the configuration information backup data is sent to a cellular phone, either by making a connection through the internet, calling the cellular phone, or any other available method of obtaining a remote connection to the cellular phone.

In step 530, a decision is made If a receipt confirmation has been received by a remote computer indicating that the configuration information backup data sent in step 520 has been received by the intended recipient, a cellular phone. If no confirmation is returned by the cellular phone, step 530 branches to step 540. If confirmation is returned by the cellular phone, the program ends.

In step 540, notification is given to the user of the remote personal computer that the configuration information backup data could not be delivered to the cellular phone, and the user should retry gaining 5access to the cellular phone at a later time.

The transfer of information between a cellular phone and a remote personal computer, can be initiated by both the cellular phone and the remote personal computer.

Access to either configuration information associated with a particular cellular phone or a personal computer can be obtained by using, e.g., a cell phone number, an internet protocol (IP) addressing, e-mail address, domain name service (DNS) addressing, etc.

Although remote personal computers 150 and 250 (FIG. 1 and FIG. 2) are shown as computers routinely within a home or business, a remote personal computer is any computing device remote from the cellular phone that is able to store configuration information and supply the configuration information to the cellular phone upon request. A remote personal computer can be, e.g., a PC, a PDA, a mainframe, a server, etc. A remote personal computer also can be any hardware within the communication system, a base station, an MSC, an HLR, etc.

In an alternative embodiment, access to the configuration information within a cellular phone is made by use of personal identification number (PIN) entered at the remote personal computer. The PIN is matched to a PIN previously entered into the cellular phone. A match between PINs is used to initiate the transfer of the configuration information between the cellular phone and the remote personal computer.

In an alternate embodiment, the configuration information is encrypted before being sent over the transmission medium. Encryption prevents interception of the data packet containing the configuration information and obtaining private information such as a PIN value, call logs, address book information, etc.

Although the present invention is described with reference to embodiments for obtaining configuration information from a cellular phone, the principles of the present invention are equally applicable to obtaining configuration information from other types of mobile electronic devices, e.g., a PDA, a pager, a laptop, etc.

While the invention has been described with reference to the exemplary embodiments thereof, those skilled in the art will be able to make various modifications to the described embodiments of the invention without departing from the true spirit and scope of the invention.

What is claimed is:

1. A system for remotely accessing configuration information comprising:
a portable wireless device having a radio transceiver;
a remote computer accessing said portable wireless device to obtain said portable wireless device's configuration information.

2. The system for remotely accessing configuration information according to claim 1, wherein:
said portable wireless device is a cellular phone.

3. The system for remotely accessing configuration information according to claim 1, wherein:
said portable wireless device is a personal data assistant.

4. The system for remotely accessing configuration information according to claim 1, wherein:
said remote computer gains access to said portable wireless device over an internet connection.

5. The system for remotely accessing configuration information according to claim 1, wherein:
said remote computer gains access to the portable wireless device over a PSTN.

6. The system for remotely accessing configuration information according to claim 1, wherein:
said remote computer sends a PIN to gain access to said portable wireless device.

7. The system for remotely accessing configuration information according to claim 1, wherein:
said configuration information is encrypted prior to being accessible by said remote computer.

8. The system for remotely accessing configuration information according to claim 1, wherein:
said configuration information is at least one of call logs (phone numbers received, phone numbers called, timestamps of phone calls, long distance calls made, local calls made, costs of calls), voice message logs, text message logs, missed call logs, remaining free minutes, address book information (names, phone numbers, addresses, e-mail addresses, personal information, birthdays), personal tones stored, digital images, schedules, appointments, PIN numbers, mail box messages, internet bookmarks, volume preferences, and display preferences.

9. A method of remotely accessing configuration information associated with a particular wireless device comprising:
receiving a data signal from a remote computer;
accessing said portable wireless device from said remote computer to obtain said configuration information belonging to said portable wireless device.

10. The method of remotely accessing configuration information according to claim 9, wherein:
said step of accessing is performed on a cellular phone.

11. The method of remotely accessing configuration information according to claim 9, wherein:
said portable wireless device is a personal data assistant.

12. The method of remotely accessing configuration information according to claim 9, wherein:
said step of accessing said portable wireless device gains access to said portable wireless device over an internet connection.

13. The method of remotely accessing configuration information according to claim 9, wherein:
said step of accessing said portable wireless device gains access to the portable wireless device over a PSTN.

14. The method of remotely accessing configuration information according to claim 9, wherein:
said step of accessing a remote computer sends a PIN to gain access to said portable wireless device.

15. The method of remotely accessing configuration information according to claim 9, further comprising:
encryption of said configuration information performed prior to said configuration information being accessible by said remote computer.

16. The method of remotely accessing configuration information according to claim 9, wherein:
said configuration information is at least one of call logs (phone numbers received, phone numbers called, timestamps of phone calls, long distance calls made, local calls made, costs of calls), voice message logs, text message logs, missed call logs, remaining free minutes, address book information (names, phone numbers, addresses, e-mail addresses, personal information, birthdays), personal tones stored, digital images, schedules, appointments, PIN numbers, mail box messages, internet bookmarks, volume preferences, and display preferences.

17. A remotely accessing means of configuration information comprising:
means for receiving a data signal from a portable wireless device;
means for accessing a remote computer from said portable wireless device to obtain said configuration information belonging to said portable wireless device.

18. The remotely accessing means of configuration information according to claim 17, wherein:
said portable wireless device is a cellular phone.

19. The remotely accessing means of configuration information according to claim 17, wherein:
said portable wireless device is a personal data assistant.

20. The remotely accessing means of configuration information according to claim 17, wherein:
said means for accessing a remote computer gains access to said portable wireless device over an internet connection.

21. The remotely accessing means of configuration information according to claim 17, wherein:
said means for accessing a remote computer gains access to the portable wireless device over a PSTN.

22. The remotely accessing means of configuration information according to claim 17, wherein:
said means for accessing a remote computer sends a PIN to gain access to said portable wireless device.

23. The remotely accessing means of configuration information according to claim 17, further comprising:
encryption means for encrypting said configuration information performed prior to said configuration information being accessible by said remote computer.

24. The remotely accessing means of configuration information according to claim 17, wherein:
said configuration information is at least one of call logs (phone numbers received, phone numbers called, timestamps of phone calls, long distance calls made, local calls made, costs of calls), voice message logs, text message logs, missed call logs, remaining free minutes, address book information (names, phone numbers, addresses, e-mail addresses, personal information, birthdays), personal tones stored, digital images, schedules, appointments, PIN numbers, mail box messages, internet bookmarks, volume preferences, and display preferences.

25. A method of providing configuration information associated with a particular wireless device to a remote computer comprising:
transceiving a configuration information request signal from said remote computer;
formatting said configuration information; and
sending said configuration information to said remote computer.

26. The method of providing configuration information to a remote computer according to claim 25, wherein:
said configuration information is at least one of call logs (phone numbers received, phone numbers called, timestamps of phone calls, long distance calls made, local calls made, costs of calls), voice message logs, text message logs, missed call logs, remaining free minutes, address book information (names, phone numbers, addresses, e-mail addresses, personal information, birthdays), personal tones stored, digital images, schedules, appointments, PIN numbers, mail box messages, internet bookmarks, volume preferences, and display preferences.

27. A method of remotely accessing configuration information associated with a particular wireless device comprising:
receiving a data signal from a remote computer;
monitoring for a return of said configuration information from a portable wireless device; and
when said step of monitoring for a return of said configuration information returns said configuration information, storing said configuration information on a permanent storage device.

28. The method of remotely accessing configuration information according to claim 27, wherein:
said permanent storage device is a hard drive.

29. The method of remotely accessing configuration information according to claim 27, wherein:
said permanent storage device is a tape drive.
